(19) United States
(12) Patent Application Publication
(10) Pub. No.: US 2026/0364939 A1
(43) Pub. Date: Nov. 19, 2026

(54) Method and installation for applying a liquid coating product by means of a print head

(71) Applicant: EXEL INDUSTRIES, EPERNAY (FR)

(72) Inventors: Nicolas CHOUAN, EPERNAY (FR); Didier CHEVRON, EPERNAY (FR)

(21) Appl. No.: 19/571,446

(22) Filed: Mar. 18, 2026

(30) Foreign Application Priority Data
Mar. 25, 2025 (FR) 2503047

(51) Int. Cl. B41J 2/045; B25J 11/00; B41J 3/407

(52) U.S. Cl. CPC B41J 2/04526; B25J 11/0075; B41J 2/04586; B41J 3/4073

(57) ABSTRACT

A method for applying a liquid coating product onto a surface to be coated, wherein a print head equipped with at least one row of print nozzles is moved opposite the surface to be coated along a trajectory including at least one pass extending along a pass axis. The method includes at least one operation consisting in compensating a capillary migration phenomenon of the coating product, between a drop of coating product being deposited and a drop or a strip of coating product already deposited, by offsetting at least one pass in progress of the trajectory, perpendicularly to its pass axis.

### CROSS-REFERENCE TO RELATED APPLICATION

This application is a U.S. non-provisional application claiming the benefit of French Application No. 25 03047, filed on Mar. 25, 2025, which is incorporated herein by reference in its entirety.

### TECHNICAL FIELD OF THE INVENTION

The present invention relates to a method for applying a liquid coating product onto a surface to be coated, wherein a print head equipped with at least one row of print nozzles is moved opposite the surface to be coated while following a trajectory.

### BACKGROUD OF THE INVENTION

Coating products have a certain capillarity specific to them, such that a drop of coating product being deposited on a surface tends to migrate toward an amount of coating product that has just been deposited and is therefore still wet and located in the immediate vicinity of the drop being deposited. This capillary migration phenomenon tends to make the positioning of a strip of coating product produced by means of a row of nozzles belonging to a print head imprecise, which may lead to a centering defect of such a strip relative to a theoretical axis of application of the coating product, or create excess thicknesses or uncoated areas at the interface between two adjacent strips or at the edge of the surface to be coated.

As emerges from FR 3111586 A1, it happens that each row of nozzles of a print head must be oriented along a direction that is not perpendicular to a direction of movement of the nozzle, in order to maintain a given spacing between lines of drops of deposited coating product, so as to guarantee a uniform deposit of coating product over an entire area. In this case, during a translational movement of the print head, all the nozzles do not apply the coating product at the same time on the surface to be coated but rather are activated in a cascading configuration, where a drop deposited by a given nozzle is attracted by a line of drops already deposited by an adjacent nozzle that is ahead in the direction of movement of the print head. Again, a capillary migration phenomenon, between a drop being deposited and drops already deposited, can disrupt the application of the coating product.

In another case, if a movement trajectory of a print head includes several successive and parallel passes, a row of nozzles may be led to apply a coating product onto an area of a surface to be coated that borders an area of this surface on which a strip of coating product has already been applied and remains wet. Capillary migration takes place between the coating product being applied and the wet strip of coating product already applied, particularly at the line of drops of coating product applied by a first nozzle immediately adjacent to the strip of coating product already applied and wet. In the opposite case, if it is the last nozzle of a row of nozzles that is adjacent to a strip of coating product already applied and wet, a reverse migration phenomenon occurs.

Other methods for applying a coating product are known from EP3643409A1, US2014/0063096A1, and DE102013002413A1.

In all cases, capillary migration, between a drop of coating product being applied and an amount of coating product already deposited and still wet, is liable to disrupt the distribution of the coating product on the surface to be coated, and thus the application accuracy.

### SUMMARY OF THE INVENTION

It is these drawbacks that the invention more particularly intends to remedy by proposing a new method for applying a coating product that is not disrupted by a capillary migration phenomenon of the coating product.

To this end, the invention relates to a method for applying a liquid coating product onto a surface to be coated, wherein a print head equipped with at least one row of print nozzles is moved opposite the surface to be coated along a trajectory including at least one pass extending along a pass axis, characterized in that it includes at least one operation consisting in compensating a capillary migration phenomenon of the coating product, between a drop of coating product being deposited and a drop or a strip of coating product already deposited, by offsetting at least one pass in progress of the trajectory, perpendicularly to its pass axis.

By means of the invention, compensation of the capillary migration phenomenon of the coating product makes it possible to ensure precise positioning of a strip of coating product applied by means of a row of nozzles, as well as of the various lines of coating product within such a strip of coating product, without capillary migration of the coating product being deposited toward an area already coated with coating product coming to disrupt this application. The risks that a strip of coating product is not correctly positioned in a transverse direction, or that excess thicknesses or uncoated areas are created, are greatly reduced, or even eliminated.

In the remainder of the present description, “migration” used alone denotes a capillary migration of drops of coating product being deposited.

According to advantageous but non-mandatory aspects of the invention, such a method may incorporate one or more of the following features, taken in any technically permissible combination:
A computer determines, from a theoretical trajectory of the print head, a corrected trajectory wherein at least one pass is offset relative to its position according to the theoretical trajectory, by an offset perpendicular to its pass axis.
The direction and/or magnitude of the offset of the pass in progress of the trajectory is/are determined taking into account the presence of a possible already-coated area of the surface adjacent to the pass in progress, and the position of this already-coated area of the surface relative to the pass in progress.
The direction and/or magnitude of the offset of the pass in progress of the trajectory is/are determined taking into account a possible inclination angle of the row of nozzles relative to the axis of the pass.
The direction and/or magnitude of the offset of the pass in progress of the trajectory is/are determined taking into account a contact angle between the coating product and the material of the surface to be coated.
For a given coating product and a given material of the surface to be coated, the magnitude of the offset of the pass in progress of the trajectory is selected from: a first absolute offset value corresponding to the case where the pass takes place without an already-coated area of the surface being adjacent to the pass of the trajectory; a second absolute offset value corresponding to the case where the pass takes place while an area of the surface already coated by a strip of coating product is adjacent to the pass of the trajectory, on a first side of the pass close to a nozzle of the row of nozzles; and a third absolute offset value corresponding to the case where the pass takes place while an area of the surface already coated by a strip of coating product is adjacent to the pass of the trajectory, on a second side of the pass, opposite the first side.
The direction and/or magnitude of the offset of the pass in progress of the trajectory is/are determined from at least one chart containing predetermined values of direction and magnitude of migration, as a function of at least the coating product and the material forming the surface to be coated.
The magnitude of the offset of the pass in progress of the trajectory is between 25% and 50% of the diameter of a drop of coating product being deposited by one of the nozzles of the row of nozzles.
The trajectory includes several successive passes, in particular adjacent passes, and the direction and/or magnitude of the offset of each pass in progress of the trajectory is/are determined taking into account the direction and/or magnitude of the offset of the preceding pass.

According to a second aspect, the invention relates to an installation for applying a liquid coating product onto a surface to be coated of an object, the installation including a print head equipped with at least one row of print nozzles, the installation including a computer configured to implement a method as described above.

### BRIEF DESCRIPTION OF THE DRAWINGS

The invention will be better understood, and other advantages thereof will appear more clearly in light of the following description of an embodiment of a method and an installation in accordance with the invention, given solely by way of example and made with reference to the appended drawings wherein:

FIG. 1 is a schematic representation of the principle of a vehicle body coating installation according to the invention, wherein a method also according to the invention is implemented;

FIG. 2 is a top view of the roof of the vehicle shown in FIG. 1 and shows a trajectory of a print head belonging to the installation shown in FIG. 1;

FIG. 3 shows, in two insets A) and B), the application of a coating product on a surface to be coated such as that shown in FIG. 2, according to the prior art, in two configurations;

FIG. 4 shows, in two insets A) and B), the application of a coating product on a surface to be coated such as that shown in FIG. 2, according to the prior art, in two other configurations;

FIG. 5 shows, in two insets A) and B), the application of a coating product, in two configurations corresponding respectively to insets A) and B) shown in FIG. 3, with implementation of the method of the invention; and

FIG. 6 shows, in two insets A) and B), the application of a coating product, in two configurations corresponding respectively to insets A) and B) shown in FIG. 4, with implementation of the method of the invention.

### DETAILED DESCRIPTION

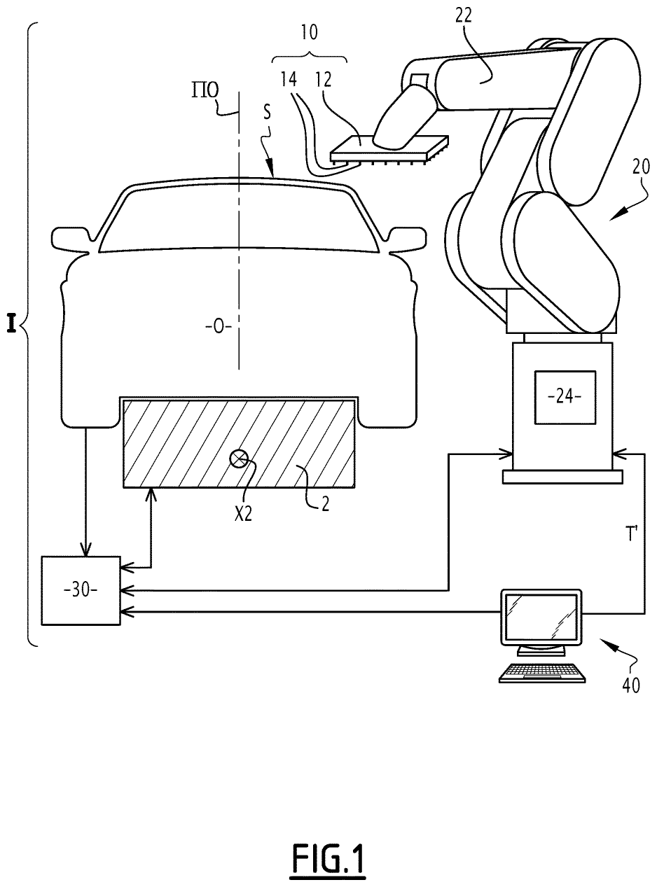

The installation I shown in FIG. 1 is intended for applying paint to objects O which, in the example shown in this figure, are motor vehicle bodies.

More specifically, in this example, installation I serves to coat the external surface S of the roof of such a body, on either side of a median plane π0 parallel to the greatest dimension of the body.

As a variant, the objects to be coated may be other parts of a motor vehicle body, for example, bumpers, doors, or more generally, any object that may be coated, for example, a portion of an aircraft fuselage or a casing of a household appliance, these examples being non-limiting.

Installation I includes a conveyor 2 intended to move objects O along a conveying axis X2, perpendicular to the plane shown in FIG. 1. This conveyor is preferably of the “stop-and-go” type, i.e., it keeps the objects immobile during application of the coating product. Installation I also includes a print head 10 mounted at the end of an arm 22 of a multi-axis robot 20 arranged near conveyor 2.

As a variant, robot 20 may be a reciprocator robot or any other robot capable of moving print head 10 relative to objects O to be coated.

Robot 20 includes a controller 24, sometimes referred to as a “robot cabinet”, which controls movements of arm 22 as a function of a predetermined theoretical trajectory T of print head 10 opposite the surface S to be coated.

In FIG. 1, the controller is shown in robot 20. It may however be arranged outside the robot.

Print head 10 includes a rigid body 12, in particular monobloc, and a number of print nozzles 14, referred to as “nozzles” in the remainder of this description.

Installation I also includes an electronic control unit (ECU) 30, which is in bidirectional communication at least with conveyor 2 and controller 24 of robot 20 and which controls print head 10. Communication between ECU 30 and controller 24 makes it possible to synchronize activation of the print head and the position of the robot arm 22. In FIG. 1, ECU 30 is shown independent of devices 2 and 20. As a variant, ECU 30 may be integrated into robot 20.

A calculation strategy is implemented to generate a corrected trajectory T′ of print head 10 opposite surface S to be coated, from theoretical trajectory T, according to the explanations that follow.

This calculation strategy is implemented in a computer 40, which is shown in FIG. 1 in the form of a computer and which communicates with ECU 30 and with controller 24. To this end, computer 40 includes at least one microprocessor and a memory storing a computer program and data necessary for implementing this program, this microprocessor and this memory not being shown. Computer 40 works offline, with a time shift relative to application of the coating product. In particular, at least part of the calculations performed by computer 40 take place before application of the coating product.

The structure of computer 40 is not limited to a computer. It may take other forms, in particular that of an electronic board. In FIG. 1, computer 40 is shown independent of devices 2 and 20 and of ECU 30. As a variant, computer 40 may be integrated into robot 20, in particular into controller 24, or into ECU 30.

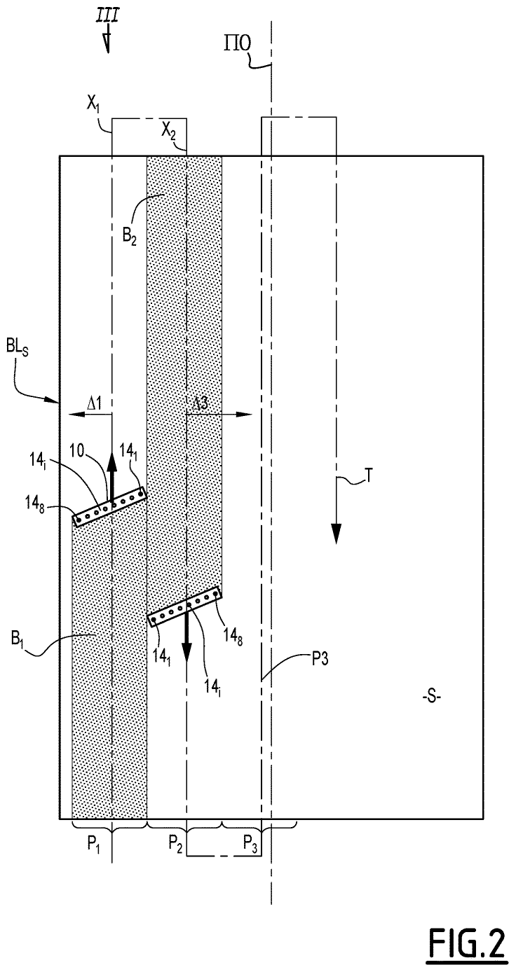

As visible in FIG. 2, predetermined theoretical trajectory T of print head 10 opposite surface to be coated S includes several passes P₁, P₂, P₃, etc. Each pass Pⱼ extends along an axis Xⱼ, with j being a natural integer between 1 and the number of passes of trajectory T.

In the example shown in the figures, each axis Xⱼ is straight and parallel to the plane π0.

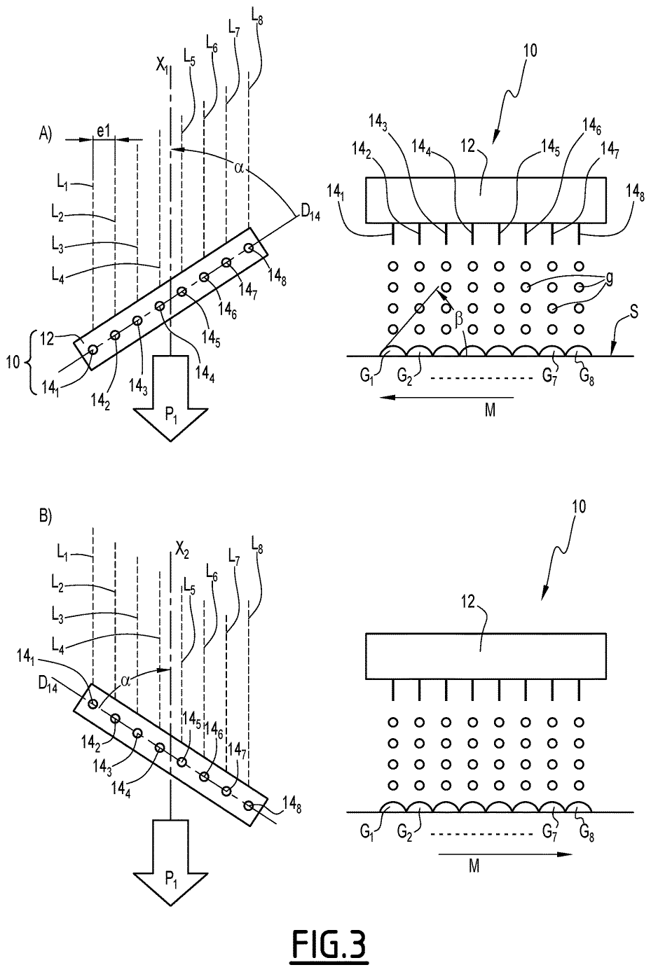

FIGS. 3-6 show print head 10 in top view and in front view when considered in the direction of arrow III in FIG. 2. In FIG. 2 and on the left-hand parts of FIGS. 3-6, body 12 is shown in top view and transparent, which makes it possible to see nozzles 14, which are eight in number and referenced 14ᵢ, with i being a natural integer between 1 and 8. Nozzle 14₁ is closest to the left end of body 12 and nozzle 14₈ is closest to the right end, in the left-hand part of FIGS. 3-6.

During movement of print head 10 along a pass Pᵢ, each nozzle 14i deposits a line Lᵢ of paint drops, with i being a natural integer between 1 and 8. Lines Lᵢ are parallel to one another and to the direction of movement of print head 10 along pass P₁ or P₂, this direction being shown by a widened arrow in FIGS. 3-6.

e1 denotes the spacing between two paint lines Lᵢ and Lᵢ₊₁. Spacing e1 is measured perpendicularly to the axis Xⱼ for each pass.

D14 denotes an oriented line passing through the centers of nozzles 14ᵢ of the row of nozzles shown in FIG. 2 and the following figures. Line D14 is oriented from nozzle 14₁ toward nozzle 14₈.

α denotes an oriented angle, defined between line D14 and the axis X of the pass in progress Pⱼ.

In the example shown in FIG. 3 and the following figures, the angle α is positive and less than 90°, preferably between 45° and 80°, more preferably around 60°, in the configuration of inset A) shown in each of FIGS. 3-6 . In the configuration of inset B) of each of these figures, angle α is negative. Advantageously, for reasons of application speed, orientation of print head 10 about an axis perpendicular to the surface to be coated and passing through the center of the print head is not changed when moving from pass P₁ to pass P₂, while direction of movement of the print head along axes X₁ and X₂ is reversed. Thus, in the configuration of inset B) shown in each of these figures, the absolute value of angle α is preferably equal to its absolute value in the configuration of inset A) of each of these figures.

The angle α is the inclination angle of the row of nozzles 14ᵢ relative to the pass axis Xⱼ for each of the passes Pⱼ. g denotes a drop of coating product in transit between a nozzle 14ᵢ and the surface S. Gᵢ, with i being a natural integer between 1 and 8, denotes a drop of coating product coming from nozzle 14ᵢ and being deposited on surface S.

Given the orientation of angle α in the configuration of insets A) shown in FIGS. 3-6, each drop Gᵢ is deposited before drop Gᵢ₊₁, for i between 1 and 7.

Thus, when drop Gᵢ₊₁ reaches surface S, it tends to migrate, by capillarity, toward a drop Gᵢ already deposited at the same level along axis X₁.

Overall, drops G₂ to G₈ tend to migrate in the direction of migration arrow M in inset A) shown in FIG. 3, i.e., toward the side of the first line of drops L₁ deposited by print head 10.

Thus, strip B₁ of coating product deposited by print head 10 along the first pass P₁ before the other passes Pⱼ tends to shift left in the right-hand part of inset A) shown in FIG. 3, i.e., to the right in FIG. 2. This amounts to saying that strip B₁ is not necessarily centered on the axis X₁ and that it may leave an uncoated area between itself and a longitudinal edge BL_{S} of surface S, as shown in FIG. 2, whereas this is not desired.

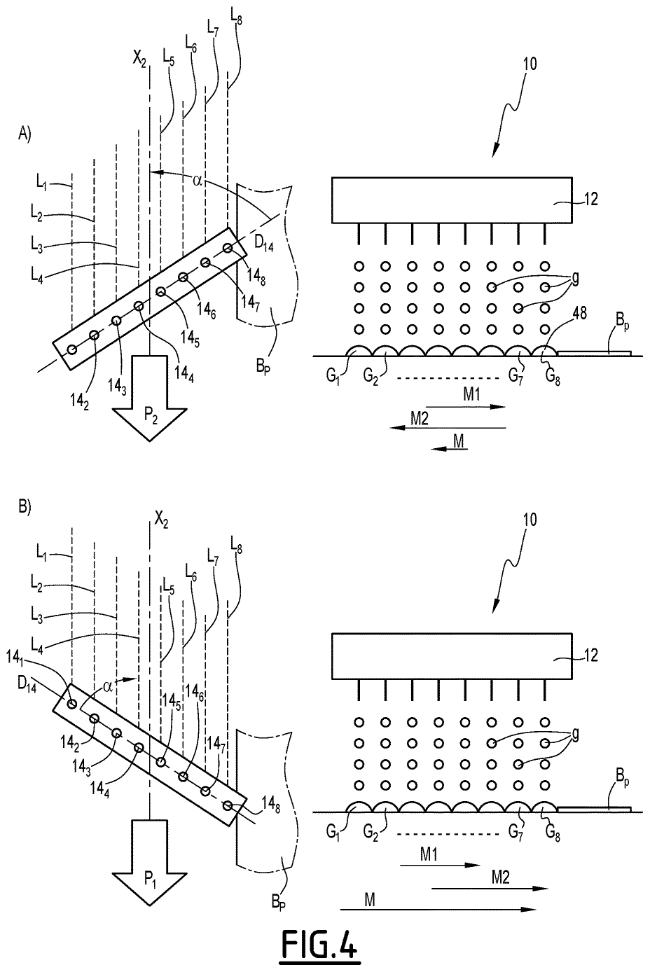

In the case shown in inset B) of FIG. 3, angle α has a negative value such that drops Gᵢ₊₁ are deposited before drops Gᵢ, for i between 1 and 7. In this case, all drops G₁ to G₇ tend to migrate rightward in the right-hand part of inset B) shown in FIG. 4, as represented by arrow M.

Inset A) of FIG. 4 shows a case where the print head is oriented as in inset A) shown in FIG. 3, with the same angle α, and where a strip B_{P} of coating product was deposited during a previous pass and has not yet finished drying.

In this case, each drop G₁ to G₈ tends to migrate, by capillarity, toward the strip B_{P}, as represented by arrow M1 on the right of inset A) shown in FIG. 4.

Moreover, according to the same phenomenon as that mentioned above regarding inset A) shown in FIG. 3, each drop G₂ to G₈ tends to migrate to the left of the right-hand part of inset A) shown in FIG. 4, as represented by arrow M2.

Inasmuch as drops Gᵢ being deposited are wetter than strip B_{P}, because they were deposited more recently, the effect of capillary migration undergone by drops Gᵢ is more intense in the direction of arrow M2 than in the direction of arrow M1, as represented by the different lengths of arrows M1 and M2. Ultimately, drops Gᵢ therefore tend to migrate to the left in the representation of the right-hand part of inset A), i.e., away from strip B_{P}, as represented by arrow M.

In the case of inset B) shown in FIG. 4, where the print head is oriented as in inset B) shown in FIG. 3, with the same angle α, the situation is reversed and the effects of migration in the direction of arrows M1, toward strip B_{P} already deposited, and of migration M2, toward drops Gᵢ₊₁, add up, which means that migration of drops Gᵢ is oriented toward the right of inset B) shown in FIG. 4, with an amplitude greater than in the case of inset A) shown in FIG. 4, as represented by arrow M.

The case of inset B) shown in FIG. 4 corresponds to that shown in FIG. 2, in the part of pass P₂ where nozzle 10 moves near strip B₁ already deposited. In this case, strip B_{P} and strip B₁ are the same physical entity.

In FIGS. 3 and 4, the length of arrows M, M1, and M2 is representative of the average magnitude of capillary migration observed on drops Gᵢ.

FIG. 2 is very schematic since it shows nozzle 10 in two successive positions, namely one position on pass P₁, the other position on pass P₂. The second position shown at pass P₂ presupposes that pass P₁ has been carried out over its entire length and that strip B₁ extends over the entire length of surface S, which is not shown in FIG. 2 for clarity of the drawing, taking into account the representation of print head 10 in an intermediate area along pass P₁.

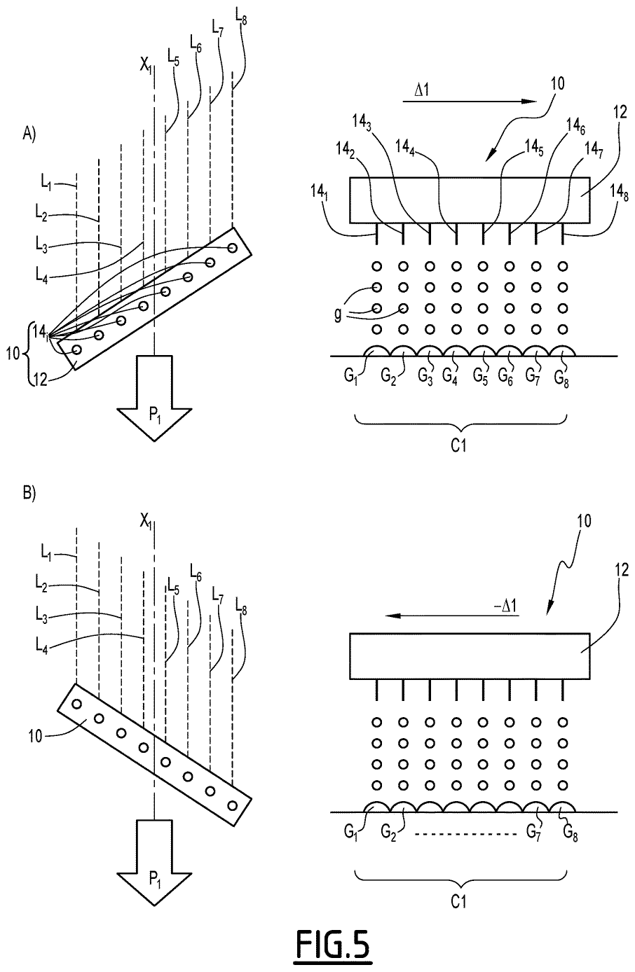

Inset A) shown in FIG. 5 shows a first implementation of the method of the invention according to which a lateral offset Δ1 of print head 10 is performed, in a direction opposite to the migration arrow M in inset A) shown in FIG. 3 and with a magnitude equal to the magnitude of migration M in inset A) shown in FIG. 3. This has the effect of re-centering the set of drops Gᵢ relative to the axis X₁.

Inset B) of FIG. 5 shows a second implementation of the method of the invention corresponding to the case of inset B) shown in FIG. 3, wherein migration M is corrected by applying an offset −Δ1, in the opposite direction to that of inset A) shown in FIG. 5, of the same magnitude.

In the example shown in FIG. 5, offset Δ1 or −Δ1 makes it possible to center the set of drops Gᵢ, both on axis X₁ and on a target area C1, which corresponds to the theoretical area of paint application according to trajectory T, from print head 10, this target area C1 being determined without taking into account capillary migration within drops G₁ to G₈.

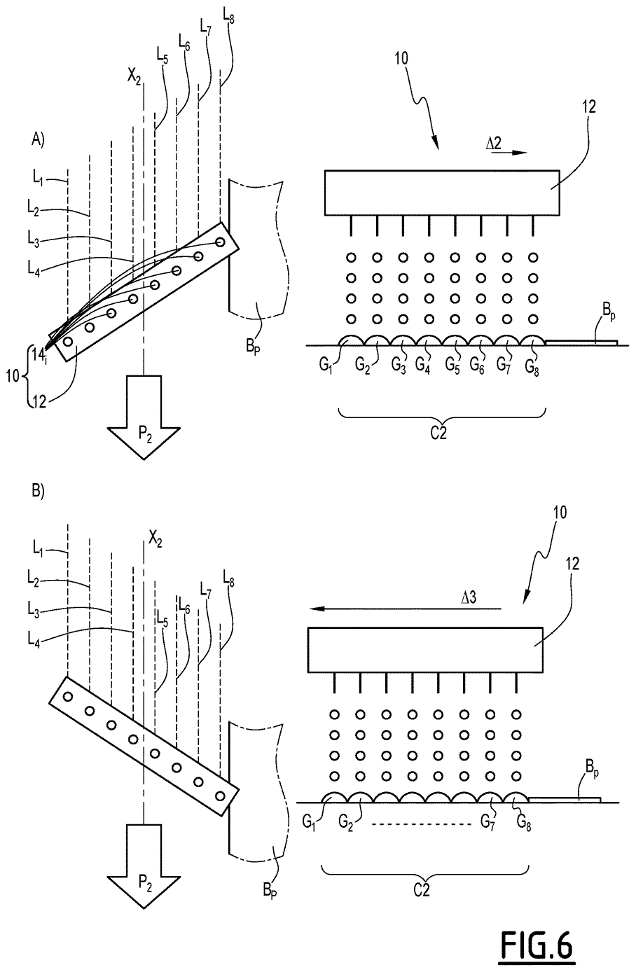

In the case of inset A) shown in FIG. 6, which shows a third implementation of the method of the invention, an offset Δ2 is applied in the direction opposite to migration M observed in inset A) of FIG. 4, to compensate for this migration.

Here, the magnitude of offset Δ2 is less than the magnitude of offset Δ1, because migration M in the case of inset A) shown in FIG. 4 is of lower magnitude than that of insets A) and B) shown in FIG. 3.

In the case of inset B) shown in FIG. 6, which shows a fourth implementation of the method of the invention, a third offset Δ3 is applied in the direction opposite to migration M observed in inset B) of FIG. 4 and with a greater magnitude than in the third implementation, making it possible to compensate for this migration. Third offset Δ3 is oriented in the same direction as offset −Δ1.

The direction and magnitude of offsets Δ2 and Δ3 are chosen so that the set of drops Gᵢ applied by print head 10 is aligned with pass axis X₂ and with a target area C2, comparable to target area C1 mentioned above.

In the example shown in FIG. 6, offset Δ2 or Δ3 makes it possible to center the set of drops Gᵢ, both on axis X₂ and on a target area C2, which corresponds to the theoretical area of paint application according to trajectory T, from print head 10, target area C2 being determined without taking into account capillary migration toward the strip B_{P} of product already deposited.

Thus, applying offsets Δ1, Δ2, or Δ3 makes it possible to realign the sets of drops Gᵢ on pass axes Xⱼ and on target areas C1, C2, etc., corresponding to theoretical trajectory T, taking account of, and compensating, the migration that takes place between drops Gᵢ being deposited on each line Lᵢ and adjacent drops already deposited, in a line Lᵢ ahead or in a strip B_{P} already present on surface S.

In practice, computer 40 generates corrected trajectory T′ by adding offsets Δ1, Δ2, or Δ3 to the passes of theoretical trajectory T, for each of the passes Pⱼ, and a complete corrected trajectory T′ is generated.

Offsets Δ1, Δ2, or Δ3 are perpendicular to axes Xⱼ of passes Pⱼ.

Advantageously, as in the example of the figures, for a given coating product and a given material of the surface S to be coated,
a first absolute value of offset Δ1 or −Δ1 corresponds to the case where pass Pⱼ takes place without an already-coated area B_{P} of surface S being adjacent to this pass of the trajectory, as in the case of FIG. 5;
a second absolute value of offset Δ2 corresponds to the case where pass Pⱼ takes place while an area of the surface S already coated by strip B_{P} is adjacent to this pass, on a first side of the pass close to nozzle 14₈ of the row of nozzles, which is the last nozzle in the direction of advance of print head 10, as in the case of inset A) shown in FIG. 6; and
a third absolute value of offset Δ3 corresponds to the case where pass Pⱼ takes place while an area of the surface already coated by strip B_{P} is adjacent to this pass of the trajectory, on a second side of the pass, opposite the first side, as in the case of inset B) shown in FIG. 6.

Direction and magnitude of each of offsets Δ1, Δ2, or Δ3 are determined, in each case, as a function of the direction and intensity of migration of drops Gᵢ being deposited.

In particular, as emerges from comparison of FIGS. 5 and 6, magnitude and direction of the offset depend in particular on the presence of strip B_{P} on surface S and on its position relative to the pass in progress, in particular relative to position and orientation of print head 10 along this pass, defined by the angle α.

The magnitude of migration of paint drops Gᵢ being deposited also depends on the value of inclination angle α of the row of nozzles 14ᵢ relative to pass axis Xⱼ, which may take a positive value, as in inset A) of FIGS. 3 and 4, or a negative value, as in inset B) of these figures. The orientation and value of this angle are advantageously taken into account in determining offsets Δ1, Δ2, and Δ3.

Another feature that may be taken into account to determine the direction and magnitude of shifts Δ1, Δ2, and Δ3 is the contact angle β between the coating product and the material of the surface to be coated S. The contact angle, or angle of connection, of a liquid on a solid is the dihedral angle formed by the surface of the solid and the surface of the liquid, along a line of contact. In general, the contact angle between a liquid and a solid may be considered representative of the wetting between that liquid and that solid. The smaller the contact angle between a solid and a liquid, the more the liquid wets the solid, reflecting a certain affinity between the two elements. The shape that a drop of liquid takes on the surface of a solid depends on the surface tension of the liquid and the nature of that surface. Thus, the contact angle may be considered representative of the surface tension between the coating product and the material of the surface to be coated. Contact angle β is shown in insert A) of FIG. 3. The smaller this contact angle, the more drops Gᵢ tend to migrate towards lines Lᵢ or the B_{P} strip already deposited. Thus, this contact angle, or any other parameter representative of wetting or surface tension, may be taken into account to determine the direction and/or amplitude of shifts Δ1, Δ2, and Δ3.

According to a first approach, the migration phenomenon encountered in each case, i.e., direction and magnitude of arrow M in the representations shown in FIGS. 3 and 4, may be determined experimentally for each pair consisting of a coating product and a material forming surface S to be coated. This experimental determination may also take into account inclination angle α, contact angle β, as well as other parameters, such as ambient temperature, ambient humidity, speed of movement of print head 10 along axis Xⱼ of pass Pⱼ in progress, the angle of the paint jet relative to the target (i.e., not the angle of the line of nozzles relative to the movement, but the perpendicularity or non-perpendicularity of the ejection axis of the drops relative to the surface to be painted), the volume of the deposited drops, and/or the quantity of drops deposited during linear movement of the nozzles.

It is thus possible to create one or more charts including predetermined values of direction and magnitude of migration, as a function of at least one coating product and at least one material forming surface to be coated S. In particular, several charts may be created, each for a pair formed by a coating product and a material forming surface to be coated S. This chart or these charts are stored in memory of computer 40. In this case, when it is appropriate to use print head 10 to apply a coating product by means of nozzles 14ᵢ, computer 40 accesses the chart corresponding to the pair in question, to know the direction and magnitude of migration M of drops Gᵢ under the assumption that trajectory T is not corrected, as in FIGS. 3 and 4. Then, computer 40 applies an offset Δ1, Δ2, or Δ3 to each pass of the trajectory, in the opposite direction to migration M and with the same magnitude, to bring the set of drops Gᵢ back onto pass axis Xⱼ and into alignment with the corresponding target. Use of offsets Δ1, Δ2, and/or Δ3 makes it possible to generate, from theoretical trajectory T, corrected trajectory T′, which is then transmitted to controller 24 by computer 40.

According to a second embodiment, it is possible to calculate, by means of computer 40, direction and magnitude of the offset Δ1, Δ2, or Δ3 to be applied, taking into account in particular the geometry of the print head, inclination angle α, presence or absence of an already-deposited strip B_{P} and/or contact angle β between the coating product and the material of surface S to be coated. Other parameters may also be taken into account during such a calculation, such as ambient temperature, ambient humidity, speed of movement of print head 10 along axis Xⱼ of pass Pⱼ in progress, the angle of the paint jet relative to the target, the volume of the deposited drops, and/or the quantity of drops deposited during the linear movement of the nozzles.

Once offsets Δ1, Δ2, and/or Δ3 have been determined, corrected trajectory T′ is generated by computer 40, also from theoretical trajectory T, and transmitted to controller 24.

According to a third embodiment, it is possible to combine the first and second approaches.

Whatever approach is used, the result of the calculation performed by computer 40 is the combination of the direction and magnitude of offset Δ1, Δ2, and/or Δ3 to be applied to bring the set of drops Gᵢ back onto the target area considered for each pass Pⱼ, namely area C1 or area C2 in the example described above, and corrected trajectory T′.

In general, the magnitude of the offset is between 25 and 50% of the diameter of a drop Gᵢ being deposited on surface to be coated S.

For example, drops Gᵢ may have a diameter of 800 μm (micrometer) and the offset applied in the cases of FIGS. 5 and 6 is advantageously between 200 and 400 μm.

Advantageously, several passes Pⱼ are implemented one after another, as in the example of FIG. 2. In this case, the offset applied for one pass preferably takes into account the offsets applied for the preceding passes.

As a variant, only one pass, or some of passes Pⱼ, of trajectory T are offset in a direction perpendicular to their pass axis Xⱼ.

It is noted in FIG. 2 that offset Δ1 applied for first pass P₁ is in the opposite direction to offset Δ3 applied for second pass P₂, which corresponds to the fact that offset arrows Δ1 and Δ3 are in opposite directions on inset A) of FIG. 5 and inset B) of FIG. 6.

In FIG. 2, the passes of the trajectory are shown with straight axes. This is, however, not mandatory, and passes with curved longitudinal axes may be used, the method of the invention then being adapted accordingly.

The invention is shown in FIG. 2 and the following figures in the case where print head 10 includes a single row of nozzles 14ᵢ. It is also applicable in the case where this print head includes several rows of nozzles, as shown in FIG. 1.

The invention is shown in the figures with three offsets Δ1, Δ2, and Δ3, which may be oriented in a first direction or in a second direction opposite the first direction. Depending on the cases, offsets −Δ2 and/or −Δ3 in the opposite direction to offsets Δ2 and/or Δ3 may be used. The number of offsets is not limiting. As a variant or in addition, other offsets, with different magnitudes, may be used.

The applied coating product may be a paint, as mentioned above, or, as a variant, another coating product, such as a primer or a varnish.

Whatever the embodiment or variant, thanks to offsets Δ1, Δ2, and/or Δ3, the invention makes it possible to compensate a capillary migration phenomenon of the coating product
between a drop Gi of coating product being deposited and a drop Gᵢ₊₁ or Gᵢ₊₁ of coating product already deposited in the same pass, depending on the orientation of angle α and/or
between a drop Gi of coating product being deposited and a strip B_{P} of coating product already deposited.

Any feature described above for one embodiment or variant is applicable to the other embodiments and variants, insofar as it is technically possible.

1. A method for applying a liquid coating product onto a surface to be coated, wherein a print head equipped with at least one row of print nozzles is moved opposite the surface to be coated along a trajectory comprising at least one pass extending along a pass axis, the method comprising compensating a capillary migration phenomenon of the coating product, between a drop of coating product being deposited and a drop or a strip of coating product already deposited, by offsetting at least one pass in progress of the trajectory, perpendicularly to its pass axis.

2. The method according to claim 1, further comprising determining, by a computer, from a theoretical trajectory of the print head, a corrected trajectory wherein at least one pass is offset relative to its position according to the theoretical trajectory, by an offset perpendicular to its pass axis.

3. The method according to claim 1, further comprising determining a direction and/or magnitude of the offset of the pass in progress of the trajectory, taking into account the presence of a possible already-coated area of the surface, adjacent to the pass in progress, and a position of this already-coated area of the surface relative to the pass in progress.

4. The method according to claim 1, further comprising determining a direction and/or magnitude of the offset of the pass in progress of the trajectory, taking into account a possible inclination angle of the row of nozzles relative to the axis of the pass.

5. The method according to claim 1, further comprising determining a direction and/or magnitude of the offset of the pass in progress of the trajectory, taking into account a contact angle between the coating product and the material of the surface to be coated.

6. The method according to claim 1, further comprising, for a given coating product and a given material of the surface to be coated, selecting a magnitude of the offset of the pass in progress of the trajectory from:
a first absolute offset value corresponding to the case where the pass takes place without an already-coated area of the surface being adjacent to the pass of the trajectory,
a second absolute offset value corresponding to the case where the pass takes place while an area of the surface already coated by a strip of coating product is adjacent to the pass of the trajectory, on a first side of the pass close to a nozzle of the row of nozzles, and
a third absolute offset value corresponding to the case where the pass takes place while an area of the surface already coated by a strip of coating product is adjacent to the pass of the trajectory, on a second side of the pass, opposite the first side.

7. The method according to claim 1, further comprising determining a direction and/or magnitude of the offset of the pass in progress of the trajectory from at least one chart containing predetermined values of direction and magnitude of migration, as a function of at least the coating product and the material forming the surface to be coated.

8. The method according to claim 1, wherein the magnitude of the offset of the pass in progress of the trajectory is between 25% and 50% of the diameter of a drop of coating product being deposited by one of the nozzles of the row of nozzles.

9. The method according to claim 1, wherein the trajectory comprises several successive passes, the method further comprising determining a direction and/or magnitude of the offset of each pass in progress of the trajectory taking into account the direction and/or magnitude of the offset of the preceding pass.

10. The method according to claim 9, wherein the several successive passes are adjacent passes.

11. An installation for applying a liquid coating product onto a surface to be coated of an object, comprising:
a print head equipped with at least one row of print nozzles; and
a computer configured to implement a method according to claim 1.
